(19) United States
(12) Patent Application Publication
(10) Pub. No.: US 2014/0362923 A1
(43) Pub. Date: Dec. 11, 2014

(54) VIDEO SIGNAL PROCESSING DEVICE, VIDEO SIGNAL OUTPUT DEVICE, AND VIDEO SIGNAL PROCESSING METHOD

(71) Applicants: Yutaka Nio, Osaka (JP); Yoshihito Ohta, Osaka (JP)

(72) Inventors: Yutaka Nio, Osaka (JP); Yoshihito Ohta, Osaka (JP)

(21) Appl. No.: 14/362,628

(22) PCT Filed: Apr. 24, 2012
(86) PCT No.: PCT/JP2012/002803

§ 371 Date: Jun. 4, 2014

(30) Foreign Application Priority Data
Dec. 14, 2011 (JP) 2011-273550

(51) Int. Cl. H04N 19/587; H04N 19/51

(52) U.S. Cl. CPC H04N 19/00751; H04N 19/00684
USPC 375/240.16

(57) ABSTRACT

A video signal processing device performs signal processing on a baseband video signal decoded from a compressed video signal, and includes: an interpolation phase generating unit which obtains frame repeat information indicating positions of identical frames output sequentially, and generates interpolation phase information for generating an interpolation frame in which a motion between frames is interpolated; a motion vector estimating unit which estimates a motion vector between mutually different frames indicated by the frame repeat information; and an interpolation frame generating unit which generates the interpolation frame using the interpolation phase information and the motion vector, and outputs an output video signal having a frame rate equal to the frame rate of the baseband video signal.

### TECHNICAL FIELD

The present invention relates to a video signal output device which decodes a compressed video signal (a video stream) and converts a frame rate, and a video signal processing device and a video signal processing method for interpolating and outputting a video.

### BACKGROUND ART

Recent years have seen an increase in the number of display devices for reproducing, for example, compressed video signals having a low frame rate through the Internet.

When such a compressed video signal is reproduced by a display device, each of frames of a decoded compressed video signal is repeated by a frame repeat process to convert the frame rate of the compressed video signal to an output frame rate of the display device.

In this case, with an object to smooth video change between the frames subjected to the frame repeat process, a technique is known which replaces a repeatedly output frame with an interpolation frame in which a motion between frames is interpolated.

When the motion between the frames is interpolated, cadence detection (for example, see Patent Literature 1) is performed to detect a video signal repeat cycle (cadence information) from a video signal, and a frame is interpolated according to the repeat cycle.

### CITATION LIST

### Patent Literature

[PTL 1]

Japanese Unexamined Patent Application Publication No. H5-183884

### SUMMARY OF INVENTION

### Technical Problem

However, the cadence detection has a problem that a change point between frames may be erroneously detected, and in this case it is impossible to appropriately interpolate a frame subjected to a frame repeat process.

In view of this, the present invention has an object to provide a video signal processing device capable of appropriately interpolating a frame subjected to a frame repeat process without erroneously detecting a repeat of a frame and a video signal processing method performed thereby.

### Solution to Problem

In order to solve the above-described problem, a video signal processing device according to an aspect of the present invention is a video signal processing device which performs signal processing on a baseband video signal generated by sequentially outputting, for each of frames obtained by decoding a compressed video signal, identical frames identical to the frame, the video signal processing device including: an interpolation phase generating unit configured to obtain frame repeat information indicating a position of a starting identical frame in the baseband video signal, and generate interpolation phase information indicating a phase for generating an interpolation frame according to a frame rate of the baseband video signal, based on the frame repeat information, the starting identical frame being included in the identical frames output sequentially for the frame; a motion vector estimating unit configured to estimate a motion vector between mutually different frames indicated by the frame repeat information; and an interpolation frame generating unit configured to generate the interpolation frame by interpolating a motion between the mutually different frames using the interpolation phase information and the motion vector, and output an output video signal which includes the mutually different frames and the interpolation frame, and has a frame rate equal to the frame rate of the baseband video signal.

These general and specific aspects may be implemented by arbitrarily combining a system, a method, an integrated circuit, a computer program, or a recording medium, or any combination of systems, methods, integrated circuits, computer programs, or computer-readable recording media.

### Advantageous Effects of Invention

The present invention makes it possible to discriminate that a repeat of a frame is due to a frame repeat process, and interpolate the frame subjected to the frame repeat process without any erroneous detection.

### BRIEF DESCRIPTION OF DRAWINGS

FIG. 1 is a block diagram showing a structure of a video signal processing device according to Embodiment 1 of the present invention.

FIG. 2 is a flowchart showing an example of a discrimination method in a frame repeat process.

FIG. 3A is a diagram showing an example of operations performed by the video signal processing device according to Embodiment 1 of the present invention.

FIG. 3B is a diagram showing relationships between iterative phases and interpolation phase information items.

FIG. 4A is a diagram showing another example of operations performed by the video signal processing device according to Embodiment 1 of the present invention.

FIG. 4B is a diagram showing relationships between iterative phases and interpolation phase information items.

FIG. 5 is a block diagram showing structures of a video signal output device and a video signal processing device according to Embodiment 2 of the present invention.

FIG. 6 is a diagram showing a data structure of a baseband video signal according to Embodiment 2 of the present invention.

FIG. 7 is a diagram showing an example of a bit assignment for frame repeat information of Embodiment 2 of the present invention.

FIG. 8 is a block diagram showing structures of a video signal output device and a video signal processing device according to Embodiment 3 of the present invention.

FIG. 9 is a block diagram showing a conventional example.

### DESCRIPTION OF EMBODIMENTS

### (Underlying Knowledge Forming Basis of the Present Disclosure)

The inventors found that the problem described in the Background Art, that is the problem which occurs when a video signal is reproduced using an interpolation frame, after frame rate conversion is performed on a decoded compressed video signal.

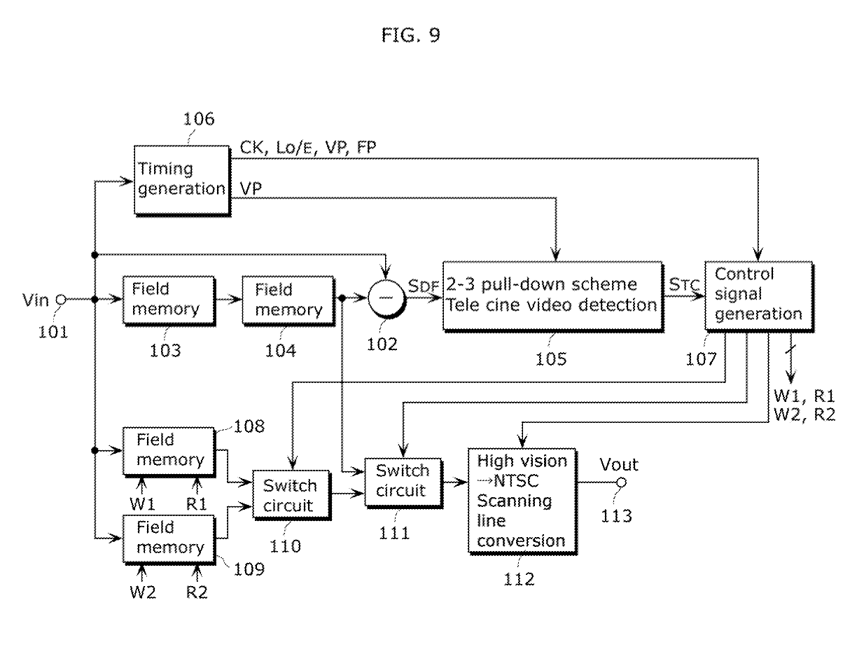

Patent Literature 1 discloses an example of a conventional frame rate conversion. First, this example is described with reference to FIG. 9.

FIG. 9 shows an example of detecting, from input video signals, a video signal repeat cycle (cadence information) indicating a Film material in which the input video signals are cyclically repeated (cadence detection), and converting a frame rate from a high vision format to an NTSC format (downconversion).

In FIG. 9, a video signal Vin of a high vision format is supplied to an input terminal 101. At the same time, the video signal Vin is also directly supplied to a direct substractor 102, and is further supplied to the substractor 102 via a field memory 103 constituting a delay circuit (delay time in one frame period) and a series circuit.

An inter-frame difference signal SDF which is output from the substractor 102 is supplied to a detector circuit 105 which detects a tele cine video signal of the 2-3 pull-down format. In addition, the video signal Vin which is supplied to the input terminal 101 is supplied to a timing generator circuit 106.

The timing generator circuit 106 is configured with a synchronization separator circuit, a PLL circuit, or the like, and outputs a clock CK, a line synchronization signal LO/E corresponding to an odd or even line, a field pulse VP, and a frame pulse FP, based on a synchronization signal etc. separated from the video signal Vin. The above-described detector circuit 105 receives supply of a field pulse VP from the timing generator circuit 106.

In addition, the conventional compressed video signal decoder which decodes a compressed video signal and the following video signal processing device have been developed for the purpose of decoding a broadcast signal. For this reason, the compressed video signal decoder has conventionally output a video signal decoded at a frame rate of 60 Hz (=60 fps) or at 50 Hz, by a frame repeat process for repeatedly outputting each of frames of a compressed video signal. In this case, with an object to smooth video change between the frames subjected to the frame repeat process, a technique is known which replaces repeatedly output frames with interpolation frames in each of which a motion between frames is interpolated.

However, cadence detection produces a problem that a compressed video signal decoder and the following processing blocks cannot discriminate whether a frame is repeated according to an intention of a content creator side or by a frame repeat process by a compressed video signal decoder.

In addition, the video signal processing device detects the cadence information calculated from frames which are output from the compressed video signal decoder, and when similar frames are consecutive, a change point between frames may be erroneously detected. Accordingly, cadence detection produces a problem that a video signal is interpolated due to an erroneous detection or the like, resulting in an artifact in the video.

In order to solve the problem, a video signal processing device according to an aspect of the present invention is a video signal processing device which performs signal processing on a baseband video signal generated by sequentially outputting, for each of frames obtained by decoding a compressed video signal, identical frames identical to the frame, the video signal processing device including: an interpolation phase generating unit configured to obtain frame repeat information indicating a position of a starting identical frame in the baseband video signal, and generate interpolation phase information indicating a phase for generating an interpolation frame according to a frame rate of the baseband video signal, based on the frame repeat information, the starting identical frame being included in the identical frames output sequentially for the frame; a motion vector estimating unit configured to estimate a motion vector between mutually different frames indicated by the frame repeat information; and an interpolation frame generating unit configured to generate the interpolation frame by interpolating a motion between the mutually different frames using the interpolation phase information and the motion vector, and output an output video signal which includes the mutually different frames and the interpolation frame, and has a frame rate equal to the frame rate of the baseband video signal.

With this structure, it is possible to prevent erroneous detection of a repeat of a frame using the frame repeat information. Accordingly, the video signal processing device is realized which is capable of appropriately interpolating the motion between the frames.

In addition, the interpolation phase generating unit may be configured to generate, based on the frame repeat information, frame update information indicating whether or not a frame included in the baseband video signal is different from an immediately preceding frame, and the motion vector detecting unit may be configured to estimate the motion vector between the mutually different frames which are indicated by the frame update information.

In addition, the video signal processing device may further include a cadence detecting unit configured to detect cadence information indicating whether or not a frame included in the baseband video signal is different, based on the baseband video signal, wherein the interpolation phase generating unit may be configured to generate the interpolation phase information, using the frame repeat information and the cadence information.

In addition, the video signal processing device may further include an HDMI obtaining unit configured to obtain a video signal which includes the baseband video signal and the frame repeat information and conforms to a High Definition Multimedia Interface (HDMI) standard, wherein the frame repeat information may be superimposed on InfoFrame of the video signal conforming to the HDMI standard.

In addition, the video signal processing device may further include a compressed video signal decoder which decodes the compressed video signal, and outputs the baseband video signal and the frame repeat information.

In addition, the compressed video signal decoder may superimpose the frame repeat information onto the baseband video signal in a blanking period, and output the baseband video signal and the frame repeat information, the blanking period being a period in which video information included in the baseband video signal is not included.

In addition, the video signal processing device may be a Large Scale Integration (LSI).

In addition, a video signal output device including a compressed video signal decoder which obtains a compressed video signal, and outputs a baseband video signal and frame repeat information, the baseband video signal being generated by sequentially outputting, for each of frames obtained by decoding the compressed video signal, identical frames identical to the frame, the frame repeat information indicating, in the baseband video signal, a position of a starting identical frame included in the identical frames output sequentially for the frame

In addition, the compressed video signal decoder may superimpose the frame repeat information onto the baseband video signal in a blanking period, and output the baseband video signal and the frame repeat information, the blanking period being a period in which video information included in the baseband video signal is not included.

In addition, the video signal output device may further include an HDMI output unit configured to output the baseband video signal and the frame repeat information as a video signal conforming to the HDMI standard, wherein the HDMI output unit is configured to superimpose the frame repeat information on InfoFrame of the video signal conforming to the HDMI standard.

In addition, a video signal processing method according to an aspect of the present invention is a video signal processing method of performing signal processing on a baseband video signal generated by sequentially outputting, for each of frames obtained by decoding a compressed video signal, identical frames identical to the frame, the video signal processing method including: obtaining frame repeat information indicating a position of a starting identical frame in the baseband video signal, and generating interpolation phase information indicating a phase of an interpolation frame to be interpolated according to a frame rate of the baseband video signal, based on the frame repeat information, the starting identical frame being included in the identical frames output sequentially for the frame; estimating a motion vector between mutually different frames indicated by the frame repeat information; and generating the interpolation frame by interpolating a motion between the mutually different frames using the interpolation phase information and the motion vector, and outputting an output video signal which includes the mutually different frames and the interpolation frame, and has a frame rate equal to the frame rate of the baseband video signal.

These general and specific aspects may be implemented by arbitrarily combining a system, a method, an integrated circuit, a computer program, or a recording medium, or any combination of systems, methods, integrated circuits, computer programs, or computer-readable recording media.

Hereinafter, embodiments of the present invention are described with reference to the drawings. Each of the exemplary embodiments described below shows a preferred example of the present invention. The numerical values, shapes, materials, structural elements, the arrangement and connection of the structural elements, etc. shown in the following exemplary embodiments are mere examples, and therefore do not limit the present invention. Therefore, among the structural elements in the following exemplary embodiments, structural elements not recited in any one of the independent claims which define the most generic concept are described as arbitrary structural elements.

### Embodiment 1

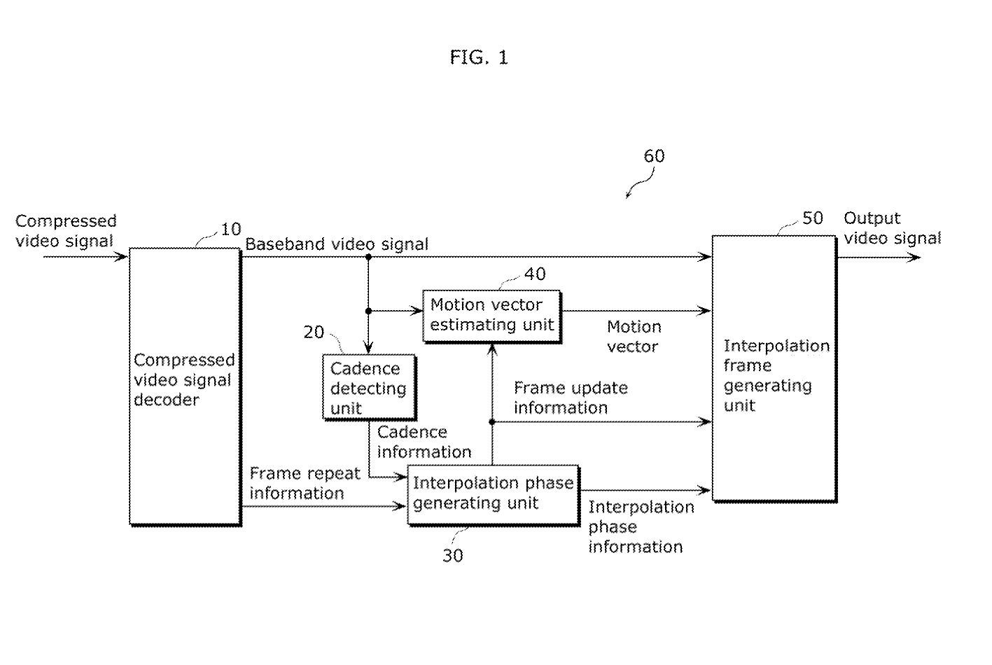

Hereinafter, a configuration of Embodiment 1 is described with reference to FIG. 1.

FIG. 1 is a block diagram showing a structure of a video signal processing device according to Embodiment 1.

A video signal processing device 60 includes: a compressed video signal decoder 10; a cadence detecting unit 20; an interpolation phase generating unit 30; a motion vector estimating unit 40; and an interpolation frame generating unit 50.

The compressed video signal decoder 10 decodes an input compressed video signal and outputs a baseband video signal and frame repeat information. The baseband video signal is a video signal generated by outputting, for each of frames included in a video signal decoded from the compressed video signal, frames identical to the frame sequentially. The frame repeat information is information indicating a position of a starting frame in the baseband video signal, among the identical frames output sequentially for the frame.

The cadence detecting unit 20 detects cadence information indicating whether or not a frame included in the baseband video signal has been updated, based on the baseband video signal.

An update of a frame means an output of a frame different from the frame output immediately before. In other words, a point at which a frame different from the immediately preceding one is a frame change point (a point of a switch between frames included in the video signal decoded from the compressed video signal) in the baseband video signal. Accordingly, a cycle of a frame update means a cycle of a frame repeat.

The interpolation phase generating unit 30 obtains the frame repeat information, and generates frame update information and interpolation phase information. The frame update information indicates whether or not a frame included in the baseband video signal has been updated. The interpolation phase information is information for interpolating a motion between the mutually different frames in the baseband video signal.

The motion vector estimating unit 40 detects a motion vector between the mutually different frames based on the baseband video signal and frame update information.

The interpolation frame generating unit 50 generates an interpolation frame using frame update information, baseband video signal, interpolation phase information, and a motion vector, and outputs an output video signal which includes the frames including the mutually different frames and the interpolation frame, and has a frame rate equal to the frame rate of the baseband video signal.

Next, operations performed by the video signal processing device 60 are described. Unless otherwise specified in the following description, the output frame rate of the compressed video signal decoder 10 is 60 Hz.

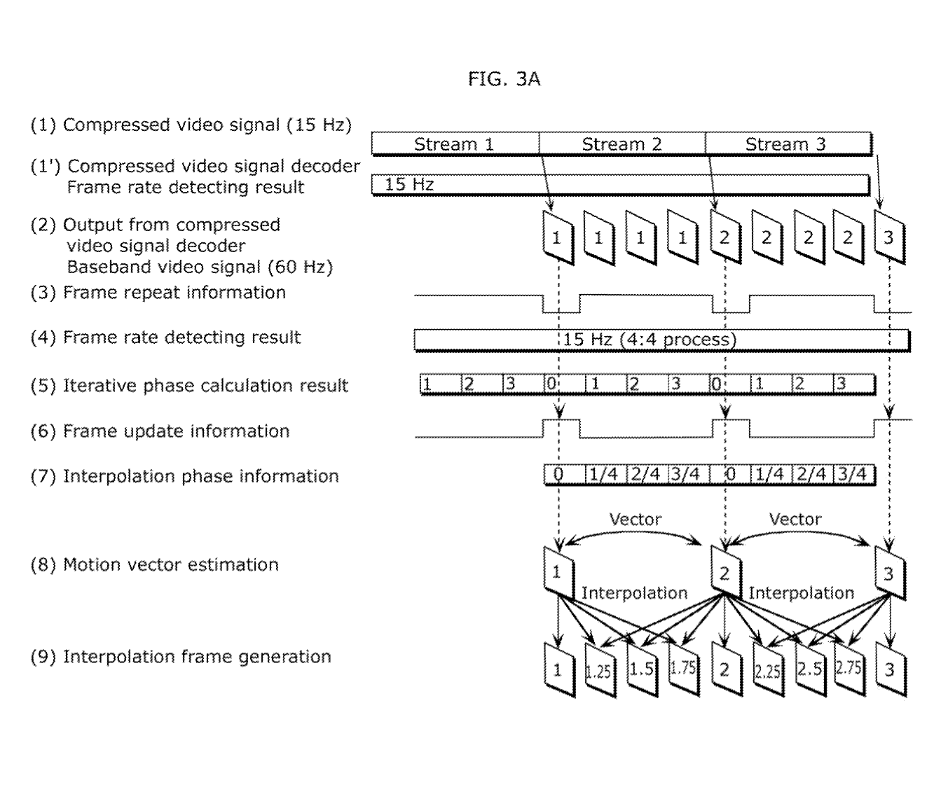

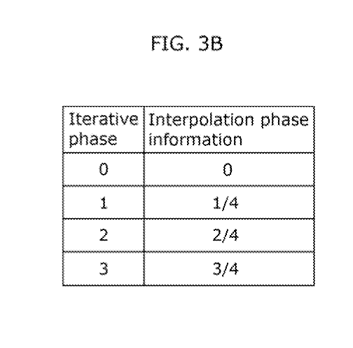

FIG. 3A is a diagram showing an example of operations by the video signal processing device 60.

First, the compressed video signal decoder 10 decodes input compressed video signals ((1) and (1′) in FIG. 3A), and outputs a baseband video signal ((2) in FIG. 3A) and frame repeat information ((3) in FIG. 3A). Here, the compressed video signal decoder 10 determines the frame rate of the compressed video signal, using frame rate information which is a part of header information included in the compressed video signal or time stamp information included in the compressed video signal. In this case, the frame rate of the compressed video signal is 15 Hz, and the output frame rate of the compressed video signal decoder 10 is 60 Hz as described above. Accordingly, the compressed video signal decoder 10 sequentially outputs, for each of frames in the video signal decoded from the compressed video signal, four frames identical to the frame. The frame denoted as “1” in (2) in FIG. 3A (hereinafter referred to as Frame 1) is a frame identical to a frame presenting a Stream 1 in the compressed video signal. Likewise, Frame 2 is a frame identical to a frame presenting a Stream 2 in the compressed video signal.

Frame repeat information shown in (3) in FIG. 3A shows a starting one of the four frames output sequentially. More specifically, the frame repeat information is a signal which has a low level value in a period in which each of starting frames is output among sequentially output four Frames 1, Frames 2, and Frames 3, and has a high level value in the other period. Here, the logic of frame repeat information (a high level period and a low level period) may be inverted. In other words, the frame repeat information is a signal which has a high level value in a period in which each of starting frames is output among sequentially output four Frames 1, Frames 2, and Frames 3, and has a low level value in the other period.

Next, the interpolation phase generating unit 30 detects the frame rate of the compressed video signal based on the ratio between the high level period and the low level period of the frame repeat information output from the compressed video signal decoder 10, and discriminates a frame repeat process.

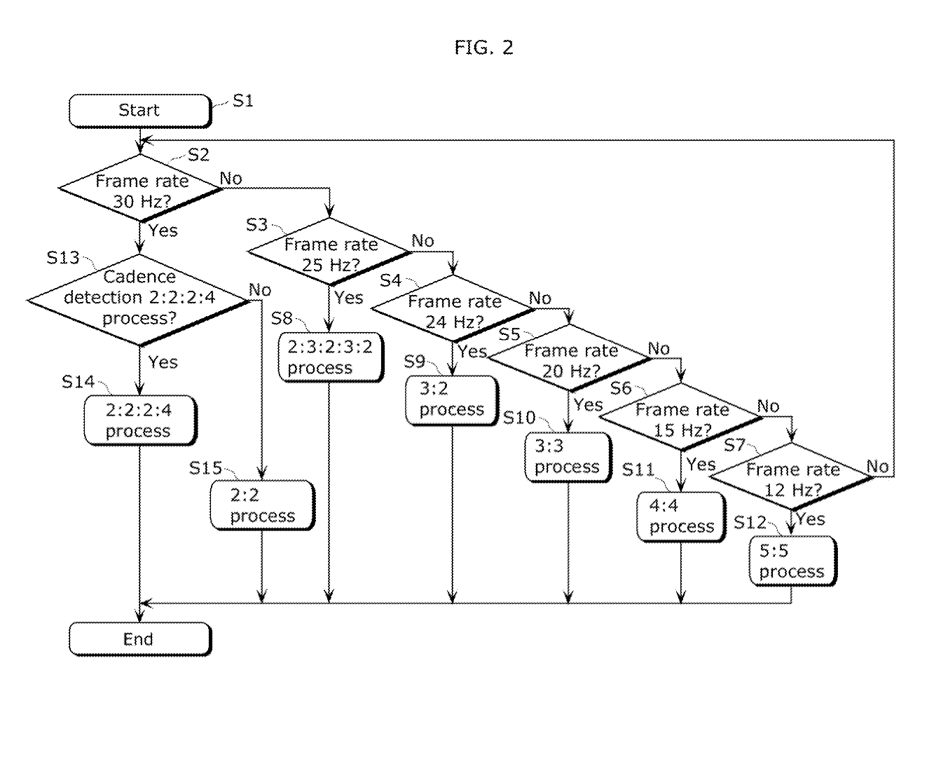

FIG. 2 is a flowchart showing an example of a method of discriminating a frame repeat process by the interpolation phase generating unit 30.

As shown in FIG. 2, the frame rate of the compressed video signal is associated with a predetermined frame repeat process by the compressed video signal decoder 10.

More specifically, when the frame rate of the compressed video signal is 30 Hz, a frame repeat process to be performed by the compressed video signal decoder 10 is a 2:2:2:4 process or a 2:2 process.

More specifically, in the case where temporally continuous Frames “1”, “2”, “3”, “4” (Streams 1 to 4) are included in a compressed video signal, a 2:2:2:4 process means, for example, the compressed video signal decoder 10 outputs Frames “1”, “1”, “2”, “2”, “3”, “3”, “4”, “4”, “4”, and “4” as frames in the baseband video signal. A frame “5” next to a Frame “4” and the following frames are output sequentially and cyclically.

Likewise, a 2:2 process means, the compressed video signal decoder 10 sequentially outputs Frames “1”, “2”, “2”, “3”, “3”, “4”, and “4” of the baseband signal decoded from the compressed video signal.

When the frame rate of the compressed video signal is 25 Hz, the frame repeat process is a 2:3:2:3:2 process, and when the frame rate of the compressed video signal is 24 Hz, the frame repeat process is a 3:2 process. Likewise, the frames rates 24 Hz, 20 Hz, 15 Hz, and 12 Hz of the compressed video signal are respectively associated with a 3:2 process, a 3:3 process, a 4:4 process, and a 5:5: process as frame repeat processes.

Since the frame rates of the compressed video signal are associated with the predetermined frame repeat process as described above, the interpolation phase generating unit 30 can discriminate the frame repeat process performed by the compressed video signal decoder 10 according to the flowchart in FIG. 2.

When the frame rate is 30 Hz (Yes in S2), the interpolation phase generating unit 30 refers to an output by the cadence detecting unit 20 (S13). As a result, when the output by the cadence detecting unit 20 shows a 2:2:2:4 process (Yes in S13), the interpolation phase generating unit 30 determines that the frame repeat process is a 2:2:2:4 process (S14). Operations by the cadence detecting unit 20 are described later. When the output by the cadence detecting unit 20 does not show a 2:2:2:4 process (No in S13), the interpolation phase generating unit 30 determines that the frame repeat process is a 2:2 process.

Hereinafter, when the frame rate is 25 Hz (Yes in S3) not 30 Hz (No in S2), the interpolation phase generating unit 30 determines that the frame repeat process is a 2:3:2:3:2 process (S8). When the frame rate is 24 Hz (Yes in S4) not 25 Hz (No in S3), the interpolation phase generating unit 30 determines that the frame repeat process is a 3:2 process (S9).

Likewise, the interpolation phase generating unit 30 determines: that the frame repeat process is a 3:3 process (S10) when the frame rate is 20 Hz (Yes in S5); that the frame repeat process is a 4:4 process (S11) when the frame rate is 15 hz (Yes in S6); and that the frame repeat process is a 5:5 process (S12) when the frame rate is 12 Hz (Yes in S7). It is to be noted that when the frame rate of the compressed video signal is not equal to any of the frame rates shown in FIG. 2 (No in S7), Steps S8 to S12 and a process for adding a process delay in the processes of S14 and S15 are performed, and a determination on the frames is performed again.

In the example of FIG. 3A, as in (4) in FIG. 3A, the interpolation phase generating unit 30 determines that the frame rate of the compressed video signal is 15 Hz (S6 in FIG. 2). Accordingly, the interpolation phase generating unit 30 determines that the frame repeat process performed by the compressed video signal decoder 10 is a 4:4 process (S11 in FIG. 2).

Here, the frame rate may be determined using frame rate information which is a part of header information included in the compressed video signal. Alternatively, the frame rate may be determined using time stamp information included in the compressed video signal. In addition, Steps S2 to S7 in FIG. 2 may be performed in a single step. In addition, the process order of Steps S2 to S7 in FIG. 2 may be modified.

Next, the interpolation phase generating unit 30 generates frame update information ((6) in FIG. 3A) and interpolation phase information ((7) in FIG. 3A).

Frame update information is information indicating a frame update (switch). In the baseband video signal, four Frames “1”, four Frames “2”, four Frames “3”, . . . included in a video signal decoded from the compressed video signal are sequentially output. An update of a frame means an output of a frame different from the frame output immediately before.

More specifically, the frame update information is a digital signal which has a high level value in a period in which each of starting frames (at update points) is output among sequentially output four Frames 1, Frames 2, and Frames 3, and has a low level value in the other period. In the example of FIG. 3A, the frame update information is a signal obtained by inverting the logic of the frame repeat information. In other words, frame update information does not always need to be generated, and the frame repeat information may be directly used.

Here, the logic of the frame update information may be inverted. In other words, the frame repeat information may be a signal which has a low level value in a period in which each of starting frames is output among sequentially output four Frames 1, Frames 2, and Frames 3, and has a high level value in the other period.

The interpolation phase information is information for generating interpolation frames in which motion vectors between frames to be output sequentially in the baseband video signal are interpolated using later-described motion vectors. In the example of FIG. 3A, the interpolation phase information is information indicating a temporal distance between frames.

For example, it is assumed that a temporal distance is “1” between a Frame “1”, a Frame “2”, and a Frame “3” . . . included in the video signal decoded from the compressed video signal. In the baseband video signal, four frames identical to each of frames included in the video signal decoded from the compressed video signal are sequentially output, and thus the temporal distance between the sequentially output frames is “0”. On the other hand, for example, the last one of four Frames “1” output sequentially and the Frame “2” output next to the last Frame “1” have a temporal distance of “1” as described above.

In this way, the temporal distances between frames included in the baseband video signal are not equal to each other, and thus smooth video display is realized by equalizing the temporal distances between the frames using interpolation frames in which motions between the frames are interpolated.

The interpolation phase information is calculated as specifically shown below.

First, an iterative phase ((5) in FIG. 3A) is calculated based on a result of detecting a frame rate (a result of determining a frame repeat process) shown in (4) of FIG. 3A. When the frame repeat process is a 4:4 process, four frames identical to each of frames included in a video signal decoded from a compressed video signal are output, and thus iterative phases of “0” to “3” are assigned respectively thereto. Here, based on the frame update information, an iterative phase “0” is assigned to a frame at an update point, and “1”, “2”, and “3” are respectively assigned to the other three frames identical to the frame.

Next, as a result of calculating an iterative phase, interpolation phase information is calculated. In Embodiment 1, for example, iterative phases and interpolation phases are associated with each other for each determined frame repeat process.

FIG. 3B is a diagram showing relationships between iterative phases and interpolation phase information items.

As shown in FIG. 3B, interpolation phase information items “0”, “¼”, “ 2/4”, and “¾” are respectively associated with iterative phases “0”, “1”, and “3”. Accordingly, for example, Frame “1” (hereinafter referred to as a Frame “1” at an update point) which is a firstly output one of Frames 1 sequentially output is associated with interpolation phase information of “0”. A second Frame “1” output next to the Frame “1” at the update point is associated with interpolation phase information of “¼”. Likewise, a third Frame “1” and a fourth Frame “1” are respectively associated with an interpolation phase information item of “ 2/4” and an interpolation phase information item of “¾”.

In this way, the interpolation phase generating unit 30 calculates interpolation phase information for each determined frame repeat process, using a table in which iterative phases and interpolation phases are associated with each other.

The motion vector estimating unit 40 calculates motion vectors between a frame and a following frame at an update point using frame update signals ((8) in FIG. 3A).

In addition, the interpolation frame generating unit 50 generates interpolation frames using a baseband video signal, motion vectors, frame update information, and interpolation phase information ((9) in FIG. 3A).

Hereinafter, detailed descriptions are given of a method of generating the motion vectors and interpolation frames. The following descriptions relate mainly to the method of generating interpolation frames which are replaced with Frames “1” output sequentially, but also apply to a case of Frames “2”, “3”, . . . .

Each of the interpolation frames is generated by performing linear interpolation on a starting frame located before an update point and a frame at the update point using the baseband video signal, a motion vector, interpolation phase information, and frame update information. For example, an interpolation frame “1.25” corresponding to an interpolation phase of “¼” shown in (9) in FIG. 3A is generated by performing linear interpolation using a motion vector calculated from a starting Frame “1” located before an update point and corresponding to interpolation phase information “0” and a starting Frame 2 at the update point.

First, the motion vector estimating unit 40 divides, for example, each of the Frame “1” before the frame update point and the Frame “2” at the frame update point into small segments.

Next, the motion vector estimating unit 40 calculates a Sum of Absolute Differences (SAD) between one of small segments (hereinafter referred to a small segment A) in the Frame “2” and each of small segments of the Frame “1”. A SAD is a parameter obtained by calculating absolute values of luminance differences between pixels of a starting frame and corresponding pixels of a second frame which is temporally consecutive to the starting frame, and summing the absolute values of the luminance differences between the pixels.

Next, the motion vector estimating unit 40 calculates a small segment (hereinafter referred to as a small segment A′) in Frame “1” before the frame update point and corresponding to the smallest one of SAD values calculated for the respective small segments. Furthermore, the motion vector estimating unit 40 calculates a motion vector A indicating a positional change from the small segment A to the small segment A′, using the small segment A and the small segment A′.

Next, the interpolation frame generating unit 50 calculates a small segment (hereinafter referred to as a small segment A″) at a position calculated according to a motion vector A′×0.25 (=interpolation phase information of ¼) from the position of the small segment A, among small segments included in an interpolation frame “1.25”.

The luminances of the respective pixels of the small segment A″ are calculated by proportional distribution between the luminances of the pixels of the small segment A and the luminances of the pixels of the small segment A′. For example, the luminance of an arbitrary pixel a in the small segment A″ is calculated according to (the luminance of a pixel a of the small segment A″)=(the luminance of a pixel corresponding to the pixel a of the small segment A)×0.25+(the luminance of the pixel corresponding to the pixel a of the small segment A′)×0.75. The values of 0.25 and 0.75 are calculated from the interpolation phase information ¼.

In this way, the luminances of the small segment A″ of the interpolation frame “1.25” are calculated by calculating the luminances of the respective pixels. As for each of the other small segments in the frame “2”, the luminances of the other small segments of the interpolation frame “1.25” are calculated by calculating motion vectors. As a result, the interpolation frame “1.25” is generated.

Likewise, the interpolation frame generating unit 50 generates interpolation frames “1.5” and “1.75” respectively corresponding to interpolation phase information items of “ 2/4” and “¾”. In addition, the same method is used to generate interpolation frames “2.25”, “2.5”, and “2.75” shown in FIG. 3A.

Lastly, the interpolation frame generating unit 50 outputs an output video signal obtained by replacing frames included in a baseband video signal with interpolation frames according to interpolation phase information. As shown in (9) in FIG. 3A, a frame corresponding to interpolation phase information “0”, that is, a frame at a frame update point is not replaced with any interpolation frame.

In this way, smooth video display is realized by equalizing the temporal distances between the frames using the interpolation frames.

It is to be noted that the video signal processing device may be configured to determine a frame repeat process using both frame repeat information and detection of cadence information.

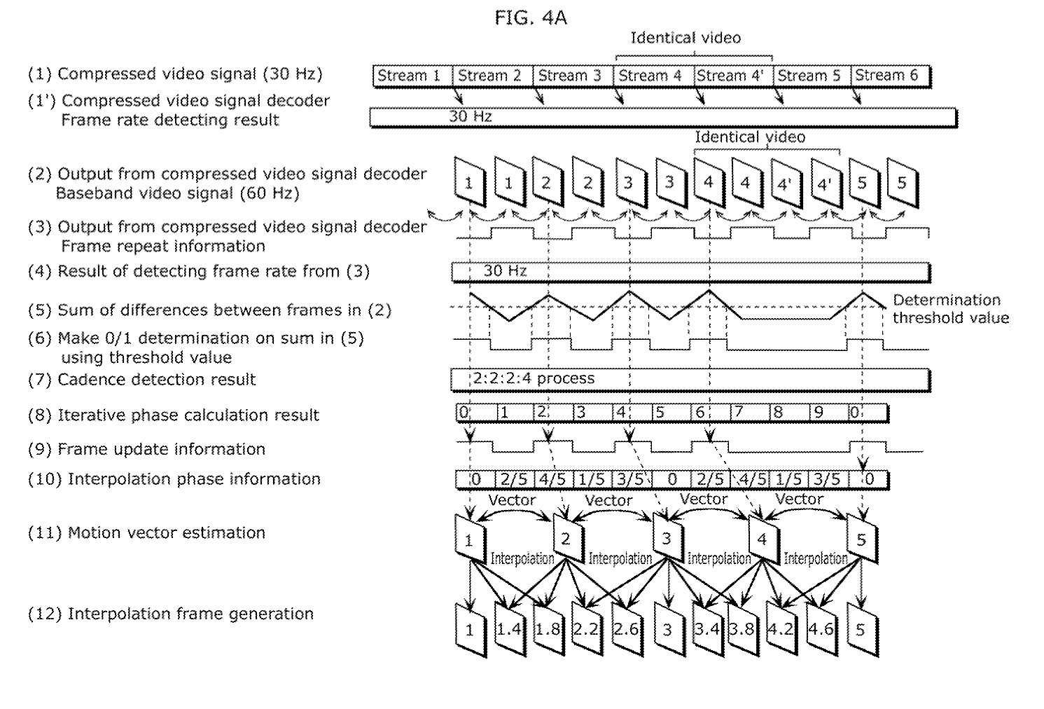

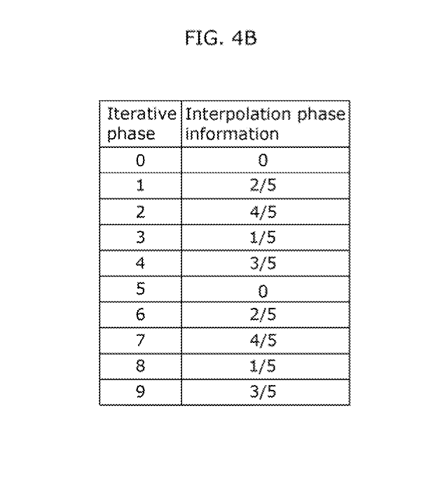

FIG. 4A is a diagram showing an example of operations by the video signal processing device 60.

In FIG. 4A, first, the compressed video signal decoder 10 decodes input compressed video signals ((1) and (1′) in FIG. 4A) and outputs a baseband video signal ((2) in FIG. 4A) and frame repeat information ((3) in FIG. 4A). In this case, the compressed video signal decoder 10 sequentially outputs frames by a 2:2:2:4 process. Accordingly, as shown in FIG. 4A, in the case of a baseband video signal, two Frames “1”, two Frames “2”, and two Frames “3” are output sequentially, and four Frames “4” are output sequentially. In other words, frames presented in a “Stream 4” in (1) of FIG. 4A and frames presented in a “Stream 4′” are identical video (frames), frames presented in a “Stream 4” in (2) of FIG. 4A and frames presented in a “Stream 4” are identical video (frames).

Frame repeat information shown in (3) in FIG. 4A is a signal which has a low level value in periods in each of which a starting one of Frames 1, Frames “4”, Frames “4′”, . . . which are output sequentially, and has a high level value in the other periods. In this case, the frame repeat information is a signal which has a frame rate of a compressed video signal.

The interpolation phase generating unit 30 detects that the frame rate of the compressed video signal is 30 Hz based on a ratio between the high level period and the low level period in the frame repeat information shown in (3) of FIG. 4A ((4) in FIG. 4A).

On the other hand, the cadence detecting unit 20 detects cadence information indicating whether or not a frame included in the baseband video signal has been updated, based on the baseband video signal ((7) in FIG. 4A). Cadence information corresponds to a digital signal ((6) in FIG. 4A) obtained by calculating absolute values of luminance differences between pixels of a starting frame in a baseband video signal shown in (2) in FIG. 4A and corresponding pixels of a second frame, summing, as the difference between the frames, the absolute values of the luminance differences between the pixels of the frames ((5) in FIG. 4A), and making a 0/1 determination on the sum using a threshold value.

The interpolation phase generating unit 30 generates frame update information ((9) in FIG. 4A) and interpolation phase information ((10) in FIG. 4A), based on a result of detecting the cadence information indicating a 2:2:2:4 process as the frame repeat process.

In order to generate interpolation phase information, the interpolation phase generating unit 30 firstly calculates iterative phases ((8) in FIG. 4A). When a frame repeat process is a 2:2:2:4 process, the frame repeat process has a cycle of every 10 frames, and the frames are respectively associated with iterative phases of “0” to “9”.

Next, based on the result of calculating the iterative phases, interpolation phase information items associated thereto are calculated.

FIG. 4B is a diagram showing relationships between iterative phases and interpolation phase information items.

As shown in FIG. 4B, the iterative phases “0” to “9” are respectively associated with interpolation phase information items “0”, “⅖”, “⅘”, “⅕”, “⅗”, “0”, “⅖”, “⅘”, “⅕”, “⅗”, and “0”. Accordingly, the interpolation phase information items are respectively associated to the frames included in the baseband video signal shown in (2) of FIG. 4A.

The motion vector estimating unit 40 detects motion vectors between frames located before and at an update point using frame update information ((9) in FIG. 4A) ((11) in FIG. 4A). The interpolation frame generating unit 50 generates interpolation frames using motion vectors, frame update information, and interpolation phase information ((12) in FIG. 4A). The motion vector detecting method and the interpolation frame generating method are the same as the methods described with reference to FIG. 3A.

Lastly, the interpolation frame generating unit 50 outputs an output video signal obtained by replacing frames included in a baseband video signal with interpolation frames according to interpolation phase information. As shown in (12) in FIG. 4A, a frame corresponding to interpolation phase information “0” is not replaced with any interpolation frame.

In an example of FIG. 4A, the frame repeat information may be a signal which directly specifies a 2:2:2:4 process as a frame repeat process. In other words, for example, the frame repeat information may be a signal obtained by inverting the logic of the cadence information shown in (6) in FIG. 4A.

In Embodiment 1, a result of detection by the cadence detecting unit 20 is used only when the frame rate of the compressed video signal is 30 Hz. However, in the case where two or more kinds of frame repeat processes are available for an identical frame rate other than 30 Hz, one of the kinds of frame repeat processes may be determined using the result of detecting the cadence information of the cadence detecting unit 20.

In addition, in Embodiment 1, the cadence detecting unit 20 is configured to detect only a 2:2:2:4 process. However, the cadence detecting unit 20 may detect cadence information or another frame repeat process.

The video signal processing device 60 according to the present invention has been described above based on Embodiment 1.

According to the video signal processing device 60, it is possible to determine a frame repeat process of a baseband video signal without fail. Accordingly, the video signal processing device 60 is capable of appropriately interpolating frames subjected to a frame repeat process.

Here, the video signal processing device 60 may output an output video signal to the display device etc., and display, on the display device etc., the result of frame rate detection in FIG. 2. In this case, as an alternative example, it is also good to display, on the display device etc., a selection menu for allowing a user to select whether or not to perform a frame interpolation process based on the frame rate detection result, before frame interpolation.

### Embodiment 2

In a video signal process, a device (a video signal output device) which decodes a compressed video signal and a device (a video signal processing device) which generates an interpolation frame are configured as separate Large Scale Integration (LSI).

In Embodiment 2, an example case of such a configuration is described with reference to the drawings. In this case, a video signal output device and a video signal processing device communicate with each other using a Low Voltage Differential Signal (LVDS).

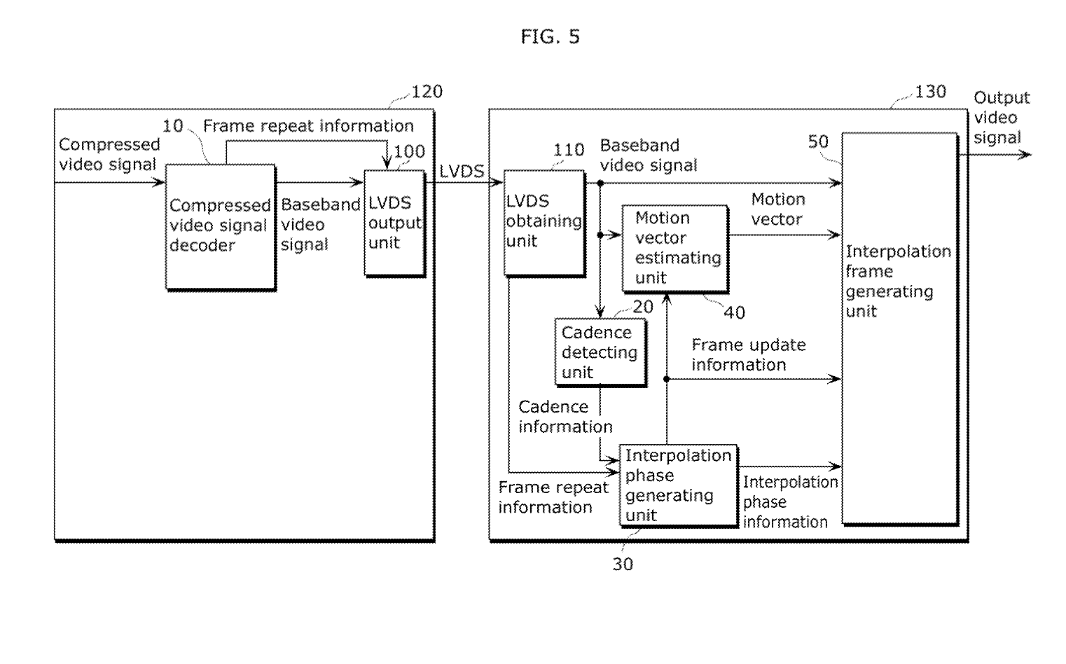

FIG. 5 is a block diagram showing structures of a video signal output device and a video signal processing device according to Embodiment 2 of the present invention. It is to be noted that structural elements having the same numerical signs as in Embodiment 1 among the structural elements have the same functions as in Embodiment 1 and performs the same operations as in Embodiment 1 unless otherwise specified. Thus, the same descriptions are not repeated here.

In FIG, 5, the video signal output device 120 is an LSI including a compressed video signal decoder 10, and an LVDS output unit 100. The video signal processing device 130 includes a cadence detecting unit 20, an interpolation phase generating unit 30, a motion vector estimating unit 40, an interpolation frame generating unit 50, and an LVDS obtaining unit 110.

The LVDS obtaining unit 110 superimposes (records) frame repeat information in a blanking period in which no video information of a baseband signal output by the compressed video signal decoder 10 is included, and output it as an LVDS.

For example, an LVDS obtaining unit 110 obtains the LVDS, and separates it into frame repeat information superimposed in the blanking period of the baseband video signal from the baseband video signal.

In addition, the LVDS obtaining unit 110 outputs the separated frame repeat information to the interpolation phase generating unit 30, and outputs the baseband video signal to the cadence detecting unit 20, the motion vector estimating unit 40, and the interpolation frame generating unit 50.

Next, a description is given of a method of superimposing frame repeat information in the blanking period of the baseband video signal.

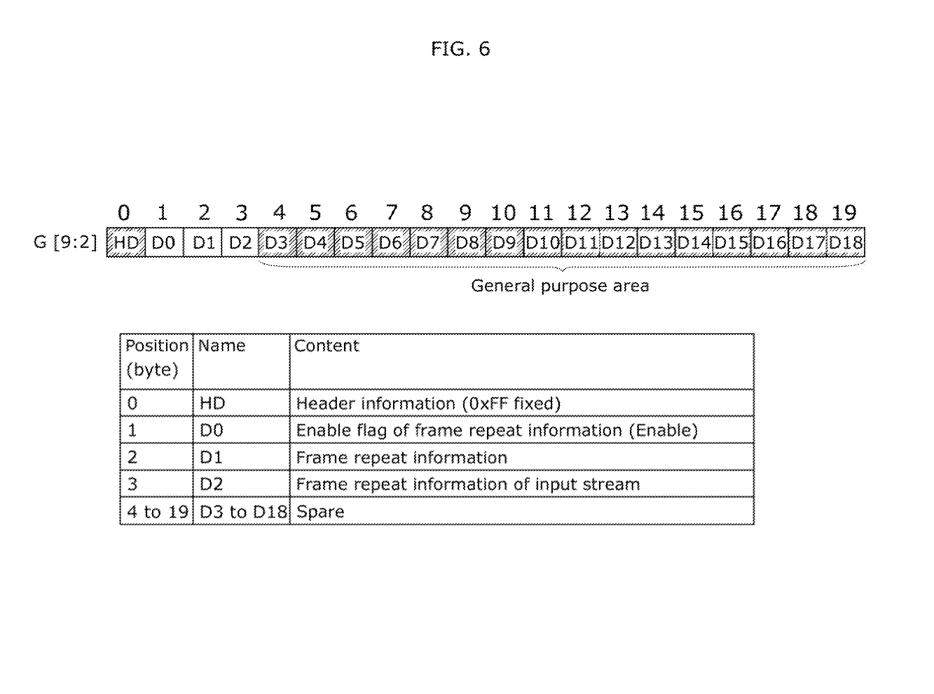

FIG. 6 is a diagram showing a data structure of a baseband video signal according to Embodiment 2. The data structure shown in FIG. 6 is 9th to 2nd bits of a signal (signal G) corresponding to green (G) of the baseband video signal.

In the example of FIG. 6, the LVDS output unit 100 superimposes frame repeat information in the blanking period of 20 bytes (8 bits×20) corresponding to 9th to 2nd bits of the signal G, and outputs the signal G.

Here, 0th byte (HD) is a fixed value FFh indicating a header of a multiplex signal, and 1st byte (D0) is an Enable flag of a Repeat flag of a decoder. In addition, 2nd byte (D1), 3rd byte (D2), and 4th to 19th bytes (D3 to D18) are frame repeat information, frame rate information of a compressed video signal (an input stream), and spare data, respectively.

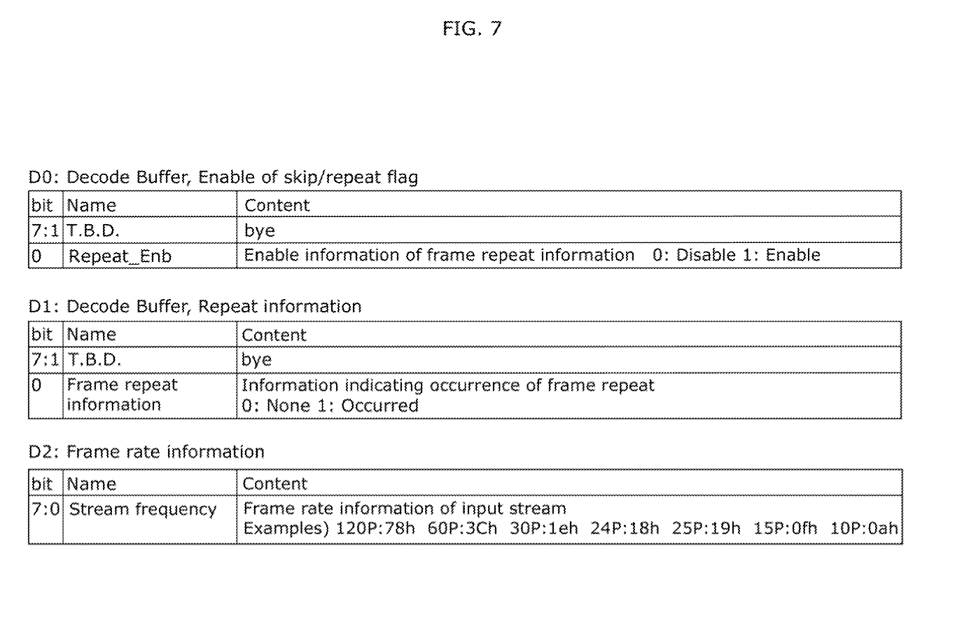

FIG. 7 is a diagram showing an example of bit assignment to frame repeat information.

The Least significant Bit (LSB) of the 1st bit (D0) is a flag indicating whether frame repeat information is Enable or Disable. For example, “0” corresponds to Disable, and “1” corresponds to Enable.

The LSB of the 2nd byte (D1) is frame repeat information. For example, “0” corresponds to no frame repeat (a starting one of consecutive identical frames), and “1” corresponding to occurrence of a frame repeat (one of the consecutive identical frames, other than the starting one).

The 3rd byte (D2) is frame repeat information of a compressed video signal (input video stream). As shown in FIG. 7, for example, when the frame rate of the compressed video signal is 30 Hz (30P in FIG. 7), D2 stores a value of 1eh (h denotes a hexadecimal number), for example, D2 stores 0fh when the frame rate of the compressed video signal is 15 Hz.

In this way, the video signal output device 120 superimposes the frame repeat information in the blanking period of the baseband video signal, and thereby can transmit the frame repeat information without modifying the data structure and the like of the baseband video signal.

Although Embodiment 2 describes an example where the video signal output device 120 and the video signal processing device 130 communicate with each other using LVDS, signals other than LVDS can also be used for communication. For example, signals used for the communication include: signals of differential signaling such as VbyOne® for inter-LSI interfaces; and signals of single-end transmission such as CMOS.

### Embodiment 3

In video signal processing, it is conceivable that a decoder (video signal output device) which decodes a compression video signal and a device (video signal processing device) which generates interpolation frames are mounted on separate devices. For example, the decoder which decodes the compression video image is a Blu-Ray player, and the device which generates the interpolation frames is a television receiver.

Embodiment 3 describes an exemplary configuration in which the video signal output device and the video signal processing device communicate with each other using an High Definition Multimedia Interface (HDMI).

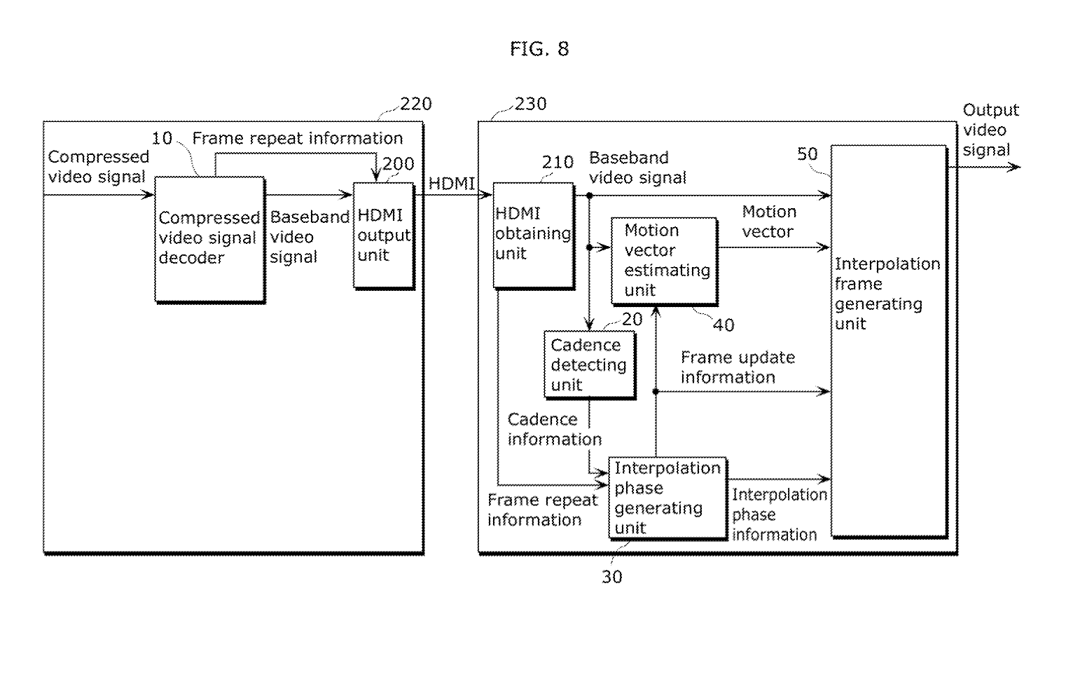

FIG. 8 is a block diagram showing structures of a video signal output device and a video signal processing device according to Embodiment 3.

The video signal output device 220 includes a compressed video signal decoder 10 and an HDMI output unit 200. The video signal processing apparatus 230 is an LSI including a cadence detecting unit 20, an interpolation phase generating unit 30, a motion vector estimating unit 40, an interpolation frame generating unit 50, and an HDMI obtaining unit 210.

The HDMI output unit 200 outputs, as a video signal conforming to the HDMI standard, a baseband video signal and decodes information including frame repeat information. The HDMI output unit 200 superimposes decode information including the frame repeat information on an InfoFrame portion of a video signal conforming to the HDMI standard.

The HDMI obtaining unit 210 obtains the video signal conforming to the HDMI standard including a baseband video signal and decode information including frame repeat information. The frame repeat information is superimposed on the InfoFrame of the video signal conforming to the HDMI standard by the HDMI output unit 200.

In this way, the video signal output device 220 superimposes the frame repeat information on the InfoFrame of the video signal conforming to the HDMI standard, and can thereby easily transmit the frame repeat information.

The video signal output device and the video signal processing device according to aspects of the present invention have been described above based on Embodiments 1 to 3. It is to be noted that the present invention can be modified as indicated below.

(1) Each of the devices are, specifically, a computer system including a microprocessor, a ROM, a RAM, a hard disk unit, a display unit, a keyboard, a mouse, and so on. A computer program is stored in the RAM or hard disk unit. Each of the devices achieves its functions through the microprocessor's operations according to the computer program. Here, in order to achieve predetermined functions, the computer program is configured by combining plural instruction codes indicating instructions for the computer.

(2) A part or all of the structural elements of each of the devices may be configured with a single system-LSI (Large-Scale Integration). The system-LSI is a super-multi-function LSI manufactured by integrating structural units on a single chip, and is specifically a computer system configured to include a microprocessor, a ROM, a RAM, and so on. A computer program is stored in the RAM. The system-LSI achieves its function through the microprocessor's operations according to the computer program.

(3) A part or all of the constituent elements constituting each of the devices may be configured as an IC card which can be attached to and detached from the respective devices or as a stand-alone module. The IC card or the module is a computer system configured from a microprocessor, a ROM, a RAM, and so on. The IC card or the module may also be included in the aforementioned super-multi-function LSI. The IC card or the module achieves its functions through the microprocessor's operations according to the computer program. The IC card or the module may also be implemented to be tamper-resistant.

(4) The present invention may be any of the methods described above. In addition, any of the methods may be implemented as computer programs for executing the above-described methods, using a computer, and may also be implemented as digital signals including the computer programs.

Furthermore, the present disclosure may also be implemented as computer programs or digital signals recorded on computer-readable recording media such as a flexible disc, a hard disk, a CD-ROM, an MO, a DVD, a DVD-ROM, a DVD-RAM, a BD (Blu-ray Disc), and a semiconductor memory. Furthermore, the present disclosure may also be implemented as the digital signals recorded on these recording media.

Furthermore, the present invention may also be implemented as the aforementioned computer programs or digital signals transmitted via a telecommunication line, a wireless or wired communication line, a network represented by the Internet, a data broadcast, and so on.

The present disclosure may also be implemented as a computer system including a microprocessor and a memory, in which the memory stores the aforementioned computer program and the microprocessor operates according to the computer program.

Furthermore, it is also possible to execute another independent computer system by transmitting the programs or the digital signals recorded on the aforementioned recording media, or by transmitting the programs or digital signals via the aforementioned network and the like.

(5) The embodiments and variations thereof may be arbitrarily combined.

The video signal output devices and video signal processing devices according to aspects of the present invention have been described above based on Embodiments 1 to 3 and variations thereof.

According to the present invention, the video signal processing device can perform signal processing on a baseband video signal to generate an output video signal using interpolation frames using frame repeat information without erroneously detecting a frame repeat process. Accordingly, it is possible to display a smooth high-quality video which looks natural to a viewer.

It is to be noted that the present invention is not limited to the embodiments. The present invention includes, within one or more aspects, various kinds of modifications that would be conceived by any person skilled in the art and made to the embodiments and other embodiments that would be configured by any person skilled in the art by combining the structural elements in different embodiments, without deviating from the scope of the present invention.

### INDUSTRIAL APPLICABILITY

The video signal processing device, the video signal output device, and the video signal processing method according to the present invention make it possible to process a baseband video signal to generate an output video signal using an interpolated frame, without erroneously detecting a frame repeat process. Accordingly, the present invention makes it possible to display a smooth high-quality video which looks natural to a viewer. The present invention is applicable to television receivers capable of reproducing compressed video signals, display devices such as personal computers, etc.

### REFERENCE SIGNS LIST

10 Compressed video signal decoder
20 Cadence detecting unit
30 Interpolation phase generating unit
40 Motion vector estimating unit
50 Interpolation frame generating unit
60, 130, 230 Video signal processing device
100 LVDS output unit
110 LVDS obtaining unit
120, 220 Video signal output device
200 HDMI output unit
210 HDMI obtaining unit

1. A video signal processing device which performs signal processing on a baseband video signal generated by sequentially outputting, for each of frames obtained by decoding a compressed video signal, identical frames identical to the frame, the video signal processing device comprising:
an interpolation phase generating unit configured to obtain frame repeat information indicating a position of a starting identical frame in the baseband video signal, and generate interpolation phase information indicating a phase for generating an interpolation frame according to a frame rate of the baseband video signal, based on the frame repeat information, the starting identical frame being included in the identical frames output sequentially for the frame;
a motion vector estimating unit configured to estimate a motion vector between mutually different frames indicated by the frame repeat information; and
an interpolation frame generating unit configured to generate the interpolation frame by interpolating a motion between the mutually different frames using the interpolation phase information and the motion vector, and output an output video signal which includes the mutually different frames and the interpolation frame, and has a frame rate equal to the frame rate of the baseband video signal.

2. The video signal processing device according to claim 1,
wherein the interpolation phase generating unit is configured to generate, based on the frame repeat information, frame update information indicating whether or not a frame included in the baseband video signal is different from an immediately preceding frame, and
the motion vector detecting unit is configured to estimate the motion vector between the mutually different frames which are indicated by the frame update information.

3. The video signal processing device according to claim 1, further comprising
a cadence detecting unit configured to detect cadence information indicating whether or not a frame included in the baseband video signal is different, based on the baseband video signal,
wherein the interpolation phase generating unit is configured to generate the interpolation phase information, using the frame repeat information and the cadence information.

4. The video signal processing device according to claim 1, further comprising
an HDMI obtaining unit configured to obtain a video signal which includes the baseband video signal and the frame repeat information and conforms to a High Definition Multimedia Interface (HDMI®) standard,
wherein the frame repeat information is superimposed on InfoFrame of the video signal conforming to the HDMI standard.

5. The video signal processing device according to claim 1, further comprising
a compressed video signal decoder which decodes the compressed video signal, and outputs the baseband video signal and the frame repeat information.

6. The video signal processing device according to claim 5,
wherein the compressed video signal decoder superimposes the frame repeat information onto the baseband video signal in a blanking period, and outputs the baseband video signal and the frame repeat information, the blanking period being a period in which video information included in the baseband video signal is not included.

7. The video signal processing device according to claim 1,
wherein the video signal processing device is a Large Scale Integration (LSI) circuit.

8. A video signal output device comprising
a compressed video signal decoder which obtains a compressed video signal, and outputs a baseband video signal and frame repeat information, the baseband video signal being generated by sequentially outputting, for each of frames obtained by decoding the compressed video signal, identical frames identical to the frame, the frame repeat information indicating, in the baseband video signal, a position of a starting identical frame included in the identical frames output sequentially for the frame.

9. The video signal output device according to claim 8,
wherein the compressed video signal decoder superimposes the frame repeat information onto the baseband video signal in a blanking period, and outputs the baseband video signal and the frame repeat information, the blanking period being a period in which video information included in the baseband video signal is not included.

10. The video signal output device according to claim 8, further comprising
an HDMI output unit configured to output the baseband video signal and the frame repeat information as a video signal conforming to the HDMI standard,
wherein the HDMI output unit is configured to superimpose the frame repeat information on InfoFrame of the video signal conforming to the High Definition Multimedia Interface (HDMI®) standard.

11. A video signal processing method of performing signal processing on a baseband video signal generated by sequentially outputting, for each of frames obtained by decoding a compressed video signal, identical frames identical to the frame, the video signal processing method comprising:
obtaining frame repeat information indicating a position of a starting identical frame in the baseband video signal, and generating interpolation phase information indicating a phase of an interpolation frame to be interpolated according to a frame rate of the baseband video signal, based on the frame repeat information, the starting identical frame being included in the identical frames output sequentially for the frame;
estimating a motion vector between mutually different frames indicated by the frame repeat information; and
generating the interpolation frame by interpolating a motion between the mutually different frames using the interpolation phase information and the motion vector, and outputting an output video signal which includes the mutually different frames and the interpolation frame, and has a frame rate equal to the frame rate of the baseband video signal.
